(19) United States
(12) Patent Application Publication
(10) Pub. No.: US 2009/0309080 A1
(43) Pub. Date: Dec. 17, 2009

(54) Turtle Winch for Stage Use

(75) Inventor: James Kempf, Wallkill, NY (US)

Correspondence Address: Law Office of Scott C Harris Inc, PO Box 1389, Rancho Santa Fe, CA, 92067, US

(73) Assignee: Production Resource Group L.L.C, New Windsor, NY (US)

(21) Appl. No.: 12/484,189

(22) Filed: Jun. 13, 2009

Related U.S. Application Data
(60) Provisional application No. 61/061,403, filed on Jun. 13, 2008.

(51) Int. Cl. B66D 1/28

(52) U.S. Cl. 254/332; 254/362

(57) ABSTRACT

A “turtle” winch that rotates relative to a non-rotatable base. The rotatable part is held in place relative to the fixed base by v shaped grooves held in cam followers.

This application claims priority from provisional application No. 61/061,403, filed Jun. 13, 2008, the entire contents of which are herewith incorporated by reference.

### BACKGROUND

Winches can be used to move various objects and scenery, especially in a stage environment.

### SUMMARY

The present application describes a rotating winch device that allows fixing to a specified location and rotating a device on top of the rotating part. An attachment part can fix to a stage track to keep the main base tightened relative to that stage track. The movable part can rotate relative to that stage track.

### BRIEF DESCRIPTION OF THE DRAWINGS

In the Drawings:

FIG. 1 shows a top view of the turtle winch;

FIG. 2 shows more detail about the drive train of the winch;

FIG. 3 shows the special sprocket with bearing race; and

FIG. 4 shows an exploded view of the different parts making up the turtle winch.

### DETAILED DESCRIPTION

The present application describes a special winch that can move laterally along a fixed path track. The laterally moving part allows rotation relative to that track.

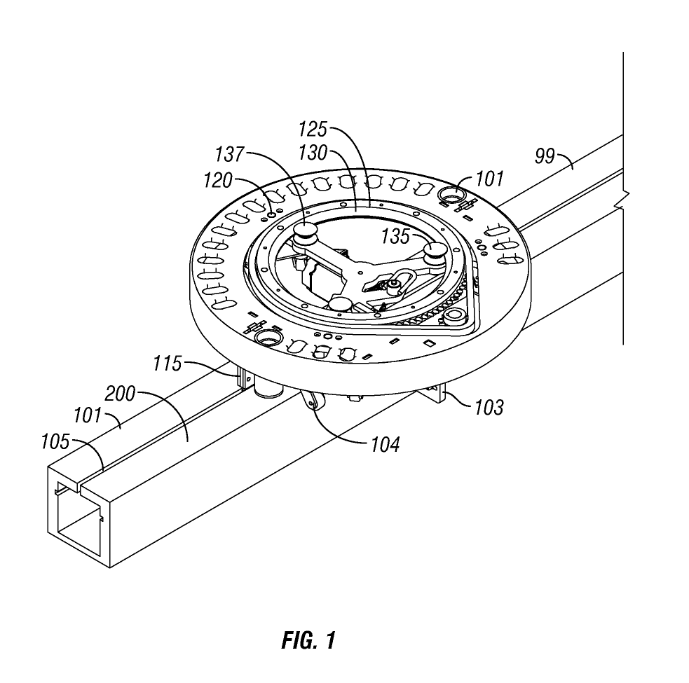

FIG. 1 shows an embodiment, where a stage surface 100 has a slot 105 therein, formed of speed track or a similar item with internal surfaces that define a path. The winch 110 is on the top surface 99 of the track. A support portion 103 on the bottom of the winch fixes to the track, using a knife 115 that fits within the speed track opening. The support portion 103 has wheels such as 200 that allow moving along the track opening 105. The knife 115 holds the rotational position of the support portion 103 in place on the track.

Rotatable top portion 101 rotates relative to the support portion 103 that is coupled to the track. One embodiment describes structure that prevents sideloading as the device rotates, even in the presence of highly asymmetric loads.

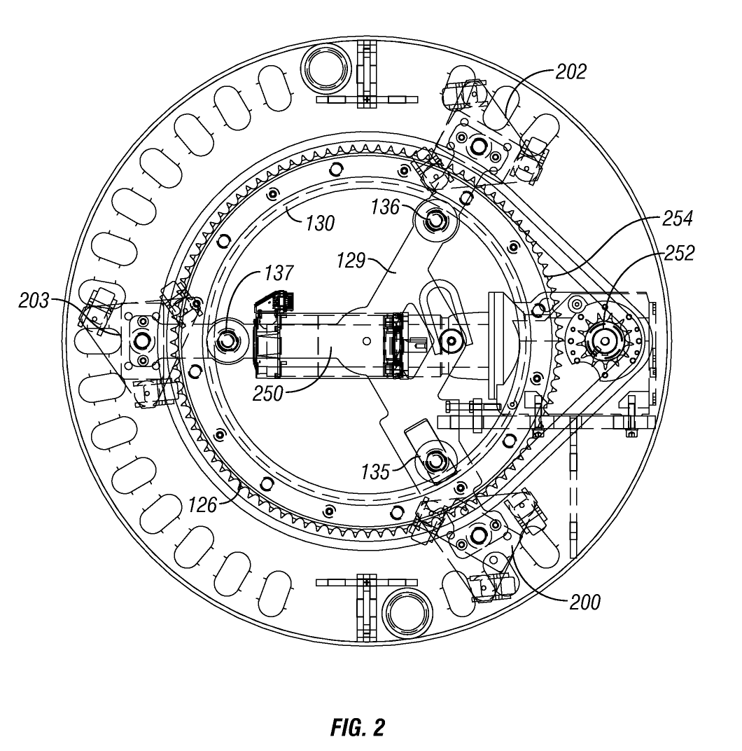

As shown in FIG. 2, the wheel assemblies 200 can be triple swivel wheel assemblies that allow turning around quickly and also without sideloading. The triple swivel assemblies 200 are at three sides of a support device 129. The wheels and support 129 and knife 115 form parts of the support portion that allows the lateral movement while preventing rotating movement.

The support 129 has holes 400, 401, 402, into which are respectively located cam followers 135, 136 and 137. Each cam follower has a V shaped groove 404 on its surface. The V shaped groove forms a fitted surface, which allows rotation of another surface relative to the V shaped groove.

In addition, there is a toothed driving wheel 125, has sprockets 126 on its outer surface which are driven by a motor 251 via sprocket 252 and chain 254. The driving wheel 125 has a V-shaped groove on its inner surface of opposite “sex”. The V-shaped groove is shaped relative to and slides against the cam followers such as 135. The wheel 125 is thus held within the cam followers 135, 136, 137, but can rotate while staying within the followers. The cam followers surround the device on its three sides, keeping the support surface straight even in the presence of off-center loads. The rotatable top portion is held by the three cam followers, in the horizontal plane relative to the non-rotatable base. Therefore, the rotation is always held parallel to the base (e.g., to the bottom support of the base), even when loaded.

In operation, a motor 250 drives a sprocket 252. The sprocket is connected by a chain 254 which presses against the outer sprocket elements 126 on the outer surface of the driving wheel 125. This rotates that outer surface, and allows it to move, thereby pivoting or moving relative to the cam followers 135, 136, 137. This movement may cause rotation of the device without sideloading effects.

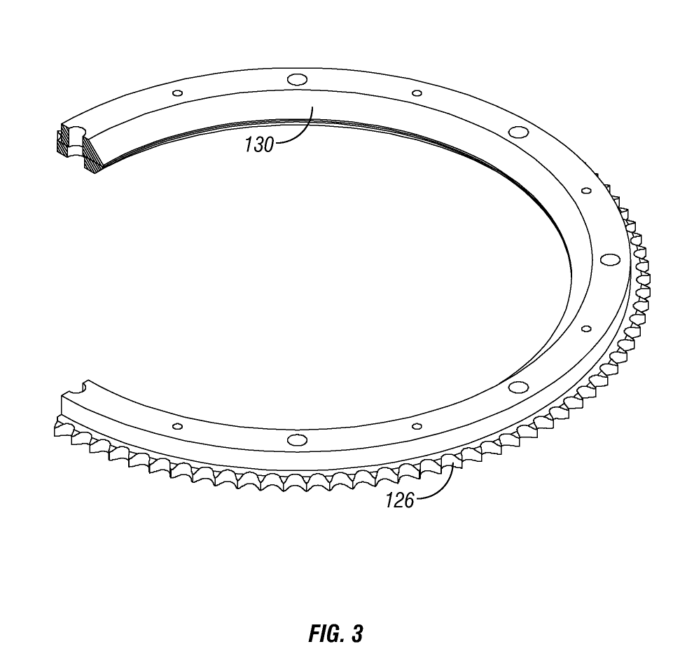

FIG. 3 shows a detail of the special sprocket chain with inner V-shaped groove.

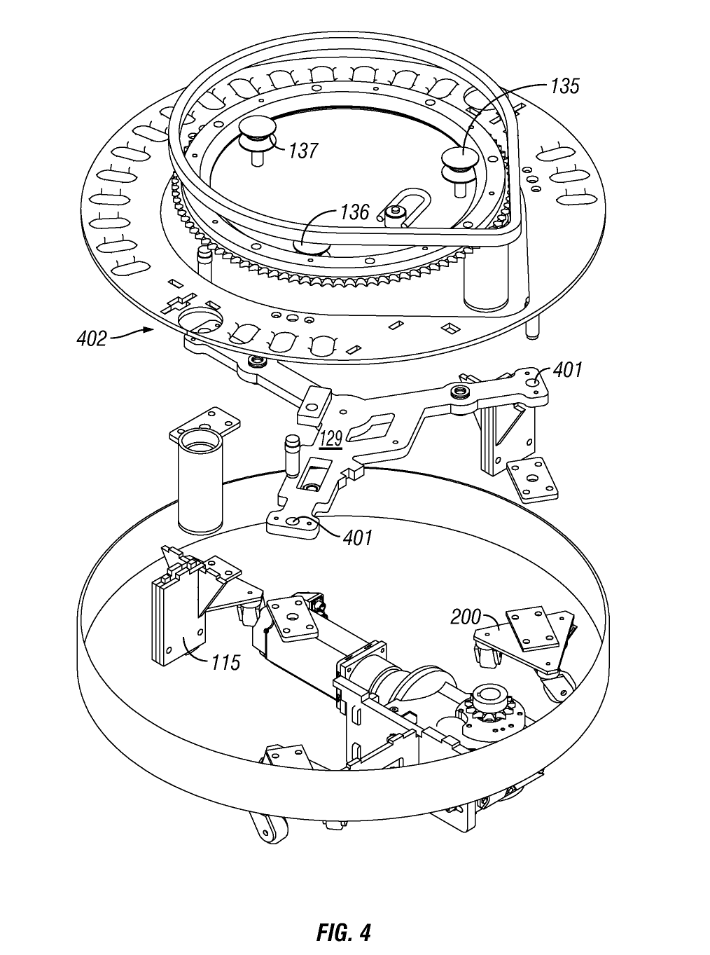

FIG. 4 shows an exploded view of the turtle winch, including the V-shaped groove bearing grease with the training socket and the cam rollers. This unit is small and efficient.

Dimensional Parameters.
Diameter: 36″
Depth: 7.75″
Weight: 255 lbs

Operating Parameter Targets—
Max load speed: 7.7 rpm
Max torque: 1650 ft-lbs
Max load travel: continuous in both directions

Examples of Turtle Applications—
Rotating scenic units or vehicles above an electrified dog driven laterally in automated deck tracks.
Rotating scenic units with the turtle fixed to the deck.
Rotating small turntables with the turtle fixed below the deck.

Turtle Mounting—
Turtle mounts to a dog below with dual ⅜″×2″ steel knives and draws power through a 22 pin linear plug.
Turtle mounts to scenic units above with up to eight ¾″ bolts.

Winch Shipping and Handling—
When not permanently mounted in a scenic unit, Turtle should travel strapped/shrink wrapped to wood pallet.

List of Purchased Mechanical Parts (Fastening Hardware not Included)—
Motor—Allen Bradley MPL-A430P
Gearbox—SEW KA47 75.2:1
Gearbox sprocket—Martin 60B13
Bearing sprocket—Martin 60A96 (subcontractor modified)
Drive chain—#60
Guide bearings—Osborn/McGill/PCI 2.5″ V-groove
Casters—BMI 300# triples
Lift ring—1000# capacity MMC

List of CNC Cut Steel Parts—
⅜″ Top plate
¾″ Gearbox plate
⅜″ Gearbox gusset
¾″ Bearing blank (subcontractor modified after CNC)
¾″ Bearing plate
⅜″ Receiver sides
⅜″ Receiver ends
⅜″ Receiver gussets
⅜″ Caster plate
½″ Pusher tab (tapped after CNC)

List of Machined Only Parts—
1½″ cold rolled steel Gearbox shaft

List of automation shop parts—
Sheet metal IJ box (off board)
Linear plug with tails to motor
Cable chain with ribbon cable

List of Subcontracted Parts or Services—
Powder coating of steel parts
Machining of bearing blank and bearing sprocket

Target Turtle Speed Calculation—
4300 rpm motor speed divided by 75.2:1 gearbox equals 57 rpm gearbox out speed passing through a 13:96 chain stage for an output bearing speed of 7.7 rpm.

Target Turtle Torque Calculation—

A 40 inlbs motor into a 75.2:1 gearbox produces 3000 inlbs of torque multiplied by 94% gearbox efficiency equals 2828 inlbs into a 13:96 chain stage that is 95% efficient produces 19830 inlbs at the output bearing divided by 12 inches per foot equals 1650 ft-lbs of continuous output torque at full speed.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other sizes, materials and connections can be used. Also, the inventors intend that only those claims which use the-words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A device comprising
a non-rotatable base;
a rotatable top portion, attached to said non-rotatable base;
a rotating motor, that rotates said rotatable top portion, relative to said non-rotatable base, wherein said rotatable top portion has a rotatable portion that is held in the horizontal plane relative to said non-rotatable base, but allowed to rotate while held in said horizontal plane.

2. A device as in claim 1, wherein said rotatable portion includes a v shaped structure coupled to said top portion, and multiple holders that hold said v shaped structure at different locations surrounding said rotatable portion.

3. A device as in claim 2, wherein there are three rollers, spaced around edges defining said v shaped grooves.

4. A device as in claim 1, further comprising rollers on said non-rotatable base, allowing moving the fixed base only linearly along a linear guide.

5. A device as in claim 4, further comprising a knife edge forming said linear guide, that prevents rotation of said fixed base and also allows movement only in a specified linear direction.

6. A device as in claim 4, wherein said rollers are each triple swivel rollers.

7. A device comprising
a non-rotatable base, said non-rotatable base having a bottom support, and at least one wheel on said bottom support, and rotation prevention structure which prevents said non rotatable base from rotating on said at least one wheel;
a rotatable portion, rotatably attached to said non-rotatable base;
a rotating motor, that rotates said rotatable top portion relative to said non-rotatable base;
a rotating guide that holds said rotatable portion by edges thereof, and maintains a top surface of said rotatable portion substantially parallel with said bottom support but allows it to rotate while held parallel with said bottom support.

8. A device as in claim 7, wherein said rotating guide includes a v shaped structure coupled to said rotatable portion, and multiple holders that slidably hold said v shaped structure relative to said non-rotatable base.

9. A device as in claim 8, wherein there are three holders, spaced around said rotatable portion.

10. A device as in claim 8, wherein said v shaped structure is on an edge of said rotating guide.

11. A device as in claim 1, wherein said rotation preventing structure includes a knife edge rigidly coupled to said non-rotatable base.

12. A rotating winch comprising
a non-rotatable base, said non-rotatable base having a bottom support, and at least multiple wheels on said bottom support, and rotation prevention structure which prevents said non rotatable base from rotating on said multiple wheels, said rotatable base having a round outer section;
a rotatable portion, rotatably attached to said non-rotatable base, said rotatable portion having a round outer section and rotating relative to said non-rotatable base, said rotatable portion having v-shaped edges;
plural guide devices, coupled to said non-rotatable base, and matched in shape to said v shaped edges and said plural guide devices collectively holding said rotatable portion between said plural guide devices, to allow rotation of said rotatable portion only in the same plane as said non rotatable base; and
a rotating motor, that rotates said rotatable portion relative to said non-rotatable base.
